(19) United States
(12) Patent Application Publication
(10) Pub. No.: US 2016/0207214 A1
(43) Pub. Date: Jul. 21, 2016

(54) STRIPPING DEVICES AND PUNCH ASSEMBLIES

(71) Applicant: Dayton Lamina Corporation, Dayton, OH (US)

(72) Inventors: James F. Folker, Dayton, OH (US); Brian S. Marsh, Dayton, OH (US)

(21) Appl. No.: 15/000,266

(22) Filed: Jan. 19, 2016

Related U.S. Application Data
(60) Provisional application No. 62/105,036, filed on Jan. 19, 2015.

(51) Int. Cl. B26D 7/18; B26F 1/14

(52) U.S. Cl. CPC B26D 7/1836; B26F 1/14

(57) ABSTRACT

A stripping device for stripping a workpiece from a punch includes a body having a sidewall that defines a bore. The bore includes a first portion and a second portion spaced at different distances from a longitudinal axis of the bore. The first portion is dimensioned such that the sidewall at least partially closes off one end of the body. A stripping element slidably engages the first portion of the body and has a sidewall. A bore of the stripping element receives the punch during operation of the stripping device. A backup plug has a circular bore and is threadably secured in the bore of the body. The circular bore is sized to guide the punch into the bore of the stripping element during assembly of the stripping device onto the punch. The stripping device includes a spring element between the backup plug and the stripping element.

### CROSS REFERENCE

This application claims priority to U.S. Provisional Patent Application Ser. No. 62/105,036 filed Jan. 19, 2015, the disclosure of which is incorporated by reference herein in its entirety.

### TECHNICAL FIELD

The present invention relates generally to punch assemblies and, more specifically, to stripping devices and punch assemblies for use during stamping processes.

### BACKGROUND

Stripping devices are known for use with various types of cutting tools. In particular, a stripping device may be used during stamping of a part. The part may be in the configuration of the metal sheet. The stripping device strips the metal sheet from the cutting element, such as a punch, during withdrawal of the punch from the sheet. During the perforating process, a front surface of a stripping element is placed against the metal sheet. When the punch is pulled out of the workpiece, the stripping element may push the metal sheet off of the punch during its withdrawal.

One problem encountered with current stripping devices is that the stripping device may rotate relative to the punch during operation. Relative rotation between the stripping element and the sheet can be a problem particularly where the part being punched has a specific orientation during machining, for example, as determined by its shape. Misalignment between the two may damage the part because the stripping element may locally deform the part in the area of misalignment leaving a visually perceptible blemish or other defect.

Another problem may be encountered during assembly of the stripping device onto the punch. Poor alignment between the punch and the stripping device may damage the stripping device or punch. Further, difficulties during installation result in greater than necessary down time and lost production.

While some strippers have been commercially successful, there exists a need for a stripper that improves assembly while limiting or eliminating relative rotation between the cutting element and the stripping device.

### SUMMARY

To address these and other drawbacks, a stripping device for stripping a workpiece from a punch includes a body having a sidewall that defines a bore. The bore includes a first portion and a second portion spaced at different distances from a longitudinal axis of the bore. The first portion is dimensioned such that the sidewall at least partially closes off one end of the body relative to the second portion. A stripping element slidably engages the first portion of the body and has a sidewall. A bore of the stripping element receives the punch during operation of the stripping device. A backup plug has a circular bore and is threadably secured in the bore of the body opposite the partially closed off end. The circular bore is sized to guide the punch into the bore of the stripping element during assembly of the stripping device onto the punch. The stripping device includes a spring element between the backup plug and the stripping element.

In one embodiment, the circular bore of the backup plug is at most 0.010 inch larger than an outside diameter of the punch.

In one embodiment, the circular bore of the backup plug is from 0.0005 inch to 0.010 inch larger than an outside diameter of the punch.

In one embodiment, the backup plug includes a recess that is configured to receive a tool to at least tighten the backup plug to the body.

In one embodiment, the backup plug includes a pair of recesses spaced apart on opposite sides of the circular bore. The recesses are configured to receive a spanner wrench.

In one embodiment, the sidewall of the stripping element has a non-circular cross section.

In one embodiment, the first portion of the bore has a non-circular profile that matches the shape of the non-circular cross section of the stripping element.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a partial cross-sectional elevation view of a punch assembly mounted for engagement with a workpiece according to one embodiment of the invention;

FIG. 2 is a perspective view of a punch assembly according to one embodiment of the invention;

FIG. 3 is a cross-sectional view taken along section line 3-3 in FIG. 2;

FIG. 4 is a top plan view of the punch assembly shown in FIG. 2;

FIG. 5 is a perspective view of a stripping member according to one embodiment of the invention;

FIG. 6 is a perspective view of a backup plug according to one embodiment of the invention; and

FIG. 7 is a plan view of the backup plug shown in FIG. 6.

### DETAILED DESCRIPTION

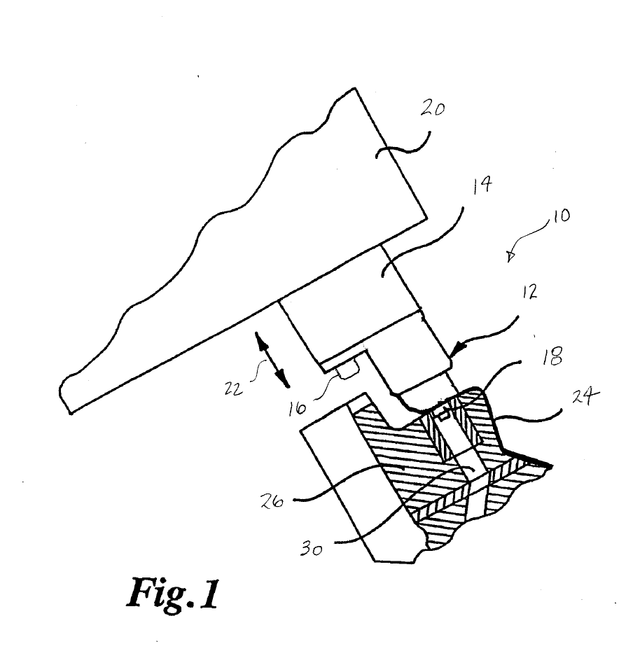

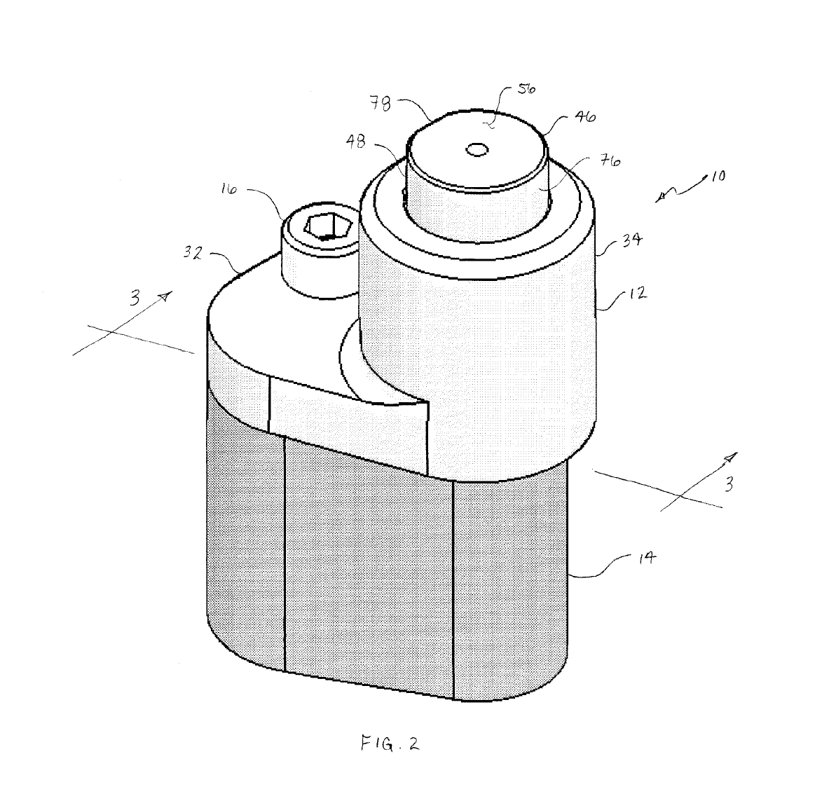

With reference to FIGS. 1 and 2, in an exemplary embodiment of the present invention, a punch assembly 10 includes a stripping device 12 secured to a punch retainer 14 with a screw 16. A punch 18 is coupled to the retainer 14. When mounted on a machine 20, reciprocating movement according to the arrow 22 forces impact between the punch assembly 10 and a workpiece 24. The punch assembly 10 is shown in contact with the workpiece 24 in FIG. 1. The workpiece 24 may be a piece of sheet metal and, as shown, the workpiece 24 may have curvature in one or more dimensions. That is, the workpiece 24 may not be flat. By the reciprocating movement, the punch 18 cuts a hole in the workpiece 24. By the same reciprocating movement, the stripping device 12 contacts the workpiece 24. Upon withdrawal of the punch 18 from the workpiece 24, the stripping device 12 forces the workpiece 24 to detach from the punch 18. While not shown, it will be appreciated that relative movement between the machine 20 and the workpiece 24 positions the punch assembly 10 at a location that allows one workpiece to be removed and another workpiece to be positioned for machining. In the exemplary embodiment shown, the punch assembly 10 may also include a mating die 26 that receives the punched out section (not shown) of the workpiece 24 within a passage 30.

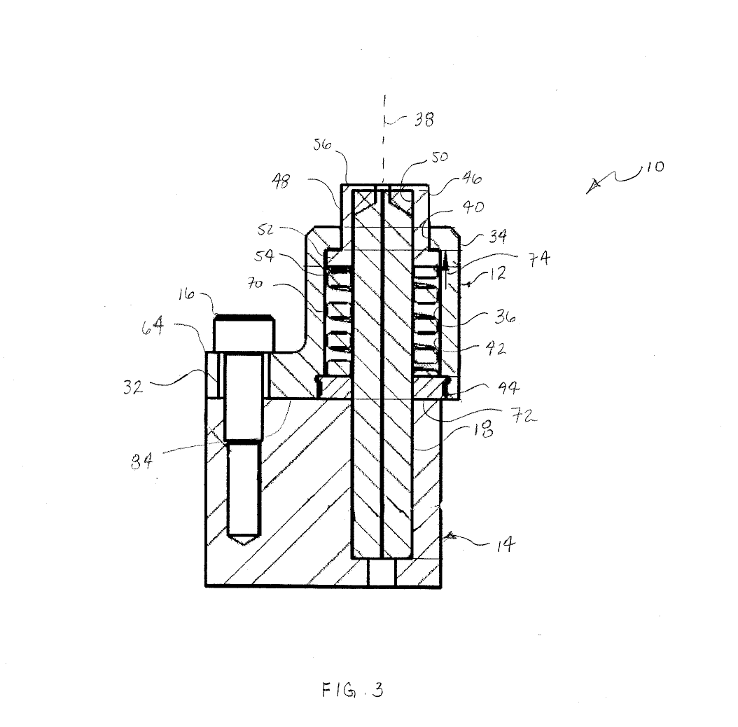

To that end, and with reference to FIGS. 2 and 3, in one embodiment of the invention, the stripping device 12 includes a body 32 having a sidewall 34 that encloses a bore 36. The sidewall 34 may define multiple dimensions for the bore 36 from a longitudinal axis 38. For example, the sidewall 34 may define a first portion 40 of the bore 36 at a distance that is closest to the longitudinal axis 38, a second portion 42 of the bore 36, and a third portion 44 of the bore 36 at a distance that is the furthest from the longitudinal axis 38.

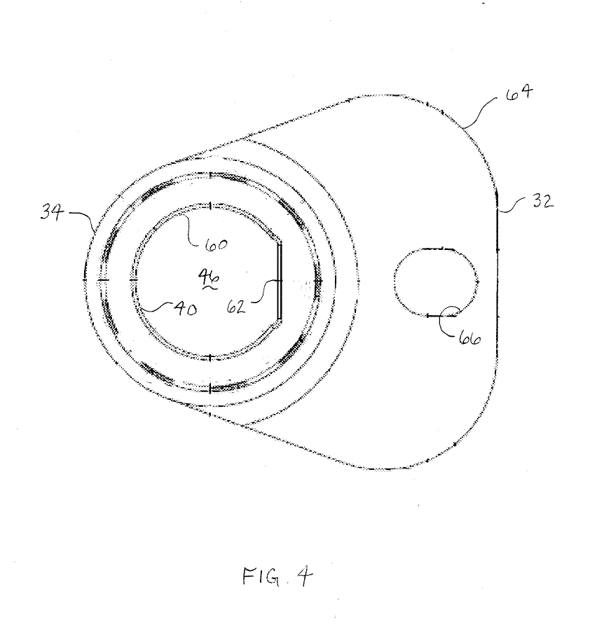

In one embodiment, as is shown best in FIG. 4, the first portion 40 has a non-circular profile so that the sidewall 34 may partially close off the bore 36 at one end of the body 32. The first portion 40 of the bore 36 is therefore positioned closer to the longitudinal axis 38 relative to one or both of the portions 42 and 44 of the bore 36. At the partially closed off end, the sidewall 34 may extend toward the longitudinal axis 38 to define a circular portion 60 and a flat 62 in the bore 36. By way of example only, the circular portion 60 and the flat 62 may have a D-shaped like profile along at least a portion of the bore 36. As is described below, the first portion 40 of the bore 36 may operate to substantially prevent relative rotation of a portion of the stripping device 12 relative to the workpiece 24.

The body 32 may also include a flange 64 that extends generally laterally from the sidewall 34. The flange 64 may have a bore 66 formed therethrough that is configured to receive the screw 16 for attachment of the stripping device 12 to the retainer 14. As shown in FIG. 3, the body 32 houses at least three other elements of the stripping device 12 within the bore 36.

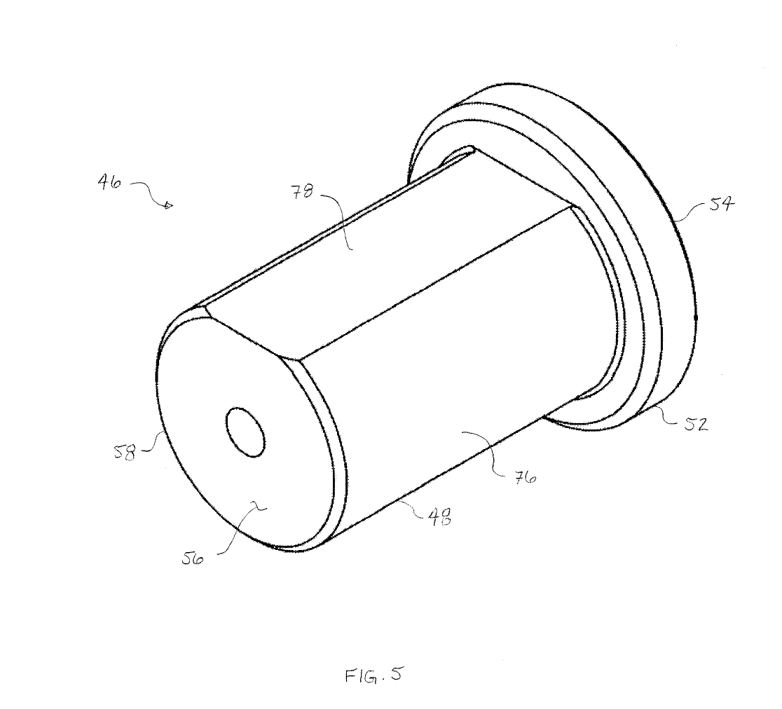

In one embodiment and with reference to FIGS. 3 and 5, the stripping device 12 includes a stripping member or stripper 46. The stripper 46 has a sidewall 48 that defines a bore 50. The punch 18 slides within the bore 50 during operation of the punch assembly 10. The sidewall 48 may include a generally perpendicular projection or head 52 that extends outwardly at one end 54 and a front surface 56 at an opposing end 58. As a result, the sidewall 48 may have a generally L-shaped cross-section (as is shown in FIG. 3). The front surface 56 of the stripper 46 contacts the workpiece 24 as is shown in FIG. 1.

In one embodiment, the sidewall 48 has a non-circular configuration in which a first portion 76 has a generally right circular cylinder shape from the head 52 to the front surface 56 with a flat portion 78 extending the length of the circular cylinder. The first portion 76 and the flat portion 78 generally define a non-circular cross section, for example, a D-shaped like cross section. In one embodiment, the non-circular cross section of the stripper 46 matches the non-circular profile of the first portion 40 of the bore 36. When assembled with the body 32, the first portion 76 and the flat portion 78 align in close proximity with the circular portion 60 and the flat 62 of the first portion 40 of the body 32. Once aligned, the stripper 46 may slide relative to the body 32 along the axis 38. However, the relationship and interaction between the flat 62 and the flat 78 may prevent rotation of the stripper 46 relative to the body 32 around the axis 38. As a result, it will be appreciated that the front surface 56 of the stripper 46 may stay in position relative to the punch 18 and so consistently contact the workpiece 24 in one orientation relative to the punch 18 during machining.

According to FIG. 3, as described above, the stripper 46 is slidably received in the bore 36 along the axis 38. When positioned at the partially closed end of the body 32, the head 52 may contact the second portion 42 of the bore 36. In conjunction with that arrangement, the sidewall 48 may slide in contact with the first portion 40 in a motion substantially parallel to the axis 38. The body 32 houses another element that interacts with the stripper 46.

In one embodiment, the stripping device 12 includes a spring element 70 that resides within the bore 36, particularly within the second portion 42 of the bore 36. The spring element 70 cooperates with the end 54 of the stripper 46 and may bias the stripper 46 to extend from the body 32 as is shown in FIGS. 2 and 3. By way of example and not limitation, the spring element 70 may include a coil spring or a disc spring, which may create higher pressure on the stripper 46. When the stripper 46 is biased in a fully extended position (shown in FIG. 3), the head 52 of the stripper 46 may abut the sidewall 34 proximate the first portion 40 of the bore 36. The sidewall 34 at the first portion 40 of the bore 36 may provide a fixed stop between the body 32 and the stripper 46.

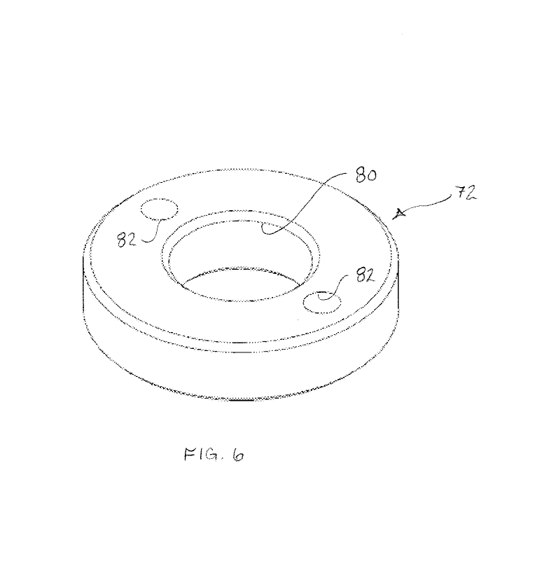

With reference to FIGS. 3 and 6, the body 32 also receives a backup plug 72. In this regard, the third portion 44 of the bore 36 may be threaded. The backup plug 72, which may also be threaded, may be threaded into the third portion 44 of the bore 36. The third portion 44 may be a larger dimension (e.g., larger in diameter) than the dimension of the second portion 42 of the bore 36. This difference in dimension results in an offset between the second portion 42 and at least a portion the third portion 44 of the bore 36. The backup plug 72 may be threaded into the third portion 44 to a predetermined depth defined by the offset. When inserted into the third portion 44, the backup plug 72 may define a planar surface 84 with the flange 64, as is shown best in FIG. 3. The surface 84 may then abut the retainer 14 when the stripping device 12 is secured to the retainer 14.

In one embodiment, the overall height dimension of the spring element 70 may be greater than the dimension between the backup plug 72 and the stripper 46 when the stripping device 12 is assembled. Accordingly, threading the backup plug 72 into the body 32 may compress the spring element 70 by a predetermined amount. Compression of the spring element 70 biases the stripper 46 in the direction of the arrow 74 in FIG. 3 with a predetermined load. It will be appreciated that when the stripper 46 contacts the workpiece 24, the spring element 70 initially applies the load to the workpiece 24 before the head 52 of the stripper 46 separates from the sidewall 34 proximate the first portion 40 as the spring element 70 is compressed during reciprocation of the punch 18 through the workpiece.

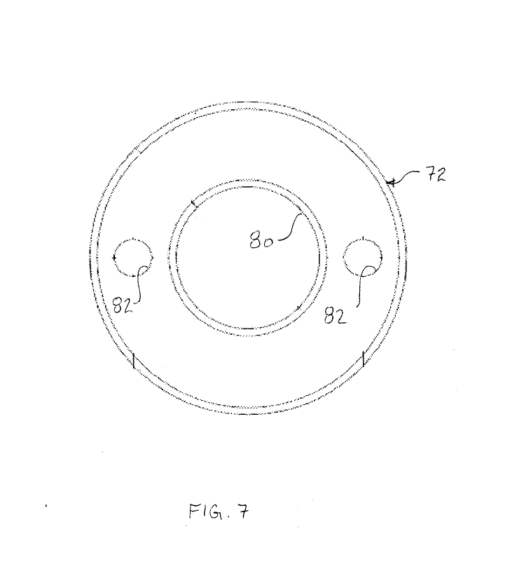

With reference to FIGS. 6 and 7, the backup plug 72 has a generally toroidal configuration with a bore 80 that receives the punch 18 (shown in FIG. 3). The bore 80 is circular with a continuous perimeter. The continuous perimeter lacks any flats or other sharp discontinuities, such as, edges designed to cooperate with a tool to tighten or loosen the backup plug 72. The circular perimeter is defined by a diameter that measures slightly larger (e.g., at most 0.010 inch) than the outside dimension of the punch 18. For example, the diameter of the circular bore 80 may measure from 0.0005 in to 0.010 inch and, by way of further example, may measure from 0.004 inch to 0.010 inch larger than the outside diameter of the punch 18. It will be appreciated that the circular bore 80 of the exemplary oversized diameter may guide insertion of the punch 18 through the punch assembly 10 when the stripping device 12 is assembled with the retainer 14. However, the bore 80 does not interfere with sliding movement of the punch 18 through the backup plug 72 during machining.

In one embodiment, the backup plug 72 may also include spaced apart recesses 82. The recesses 82 may be in the configuration of through bores. Although not shown, the recesses 82 may alternatively be configured as blind bores. The recesses 82 receive a tool, such as, a spanner wrench, for tightening and loosening the backup plug 72 within the third portion 44 of the bore 36 during assembly and disassembly of the stripping device 12.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. A stripping device for stripping a workpiece from a punch, the stripping device comprising:
a body having a sidewall defining a bore along a longitudinal axis, the bore having a first portion and a second portion spaced at different distances from the longitudinal axis, the first portion being dimensioned such that the sidewall at least partially closes off one end of the body relative to the second portion;
a stripping element having a sidewall defining a bore and being slidably engaged with the first portion of the bore of the body along the longitudinal axis, the bore receiving the punch during operation of the stripping device;
a backup plug having a circular bore and being threadably secured in the bore opposite the partially closed off end of the body, the circular bore being sized to guide the punch into the bore of the stripping element during assembly of the stripping device onto the punch; and
a spring element between the backup plug and the stripping element.

2. The stripping device of claim 1, wherein the circular bore of the backup plug is at most 0.010 inch larger than an outside diameter of the punch.

3. The stripping device of claim 1, wherein the circular bore of the backup plug is from 0.0005 inch to 0.010 inch larger than an outside diameter of the punch.

4. The stripping device of claim 1, wherein the backup plug includes a recess that is configured to receive a tool to at least tighten the backup plug to the body.

5. The stripping device of claim 1, wherein the backup plug includes a pair of recesses spaced apart on opposite sides of the circular bore, the recesses being configured to receive a spanner wrench.

6. The stripping device of claim 1, wherein the sidewall of the stripping element has a non-circular cross section.

7. The stripping device of claim 6, wherein the first portion of the bore has a non-circular profile that matches the shape of the non-circular cross section of the stripping element.
